(19) United States
(12) Patent Application Publication
(10) Pub. No.: US 2011/0075647 A1
(43) Pub. Date: Mar. 31, 2011

(54) Method for Sending and Receiving Signaling in a Multiple Carrier Frequency Communication System

(75) Inventors: Kun Liu, Guangdong Province (CN); Zhaohua Lu, Guangdong Province (CN); Ying Liu, Guangdong Province (CN)

(73) Assignee: ZTE CORPORATION, Nanshan District, Shenzhen, Guangdong (CN)

(21) Appl. No.: 12/993,601

(22) PCT Filed: Dec. 30, 2008
(86) PCT No.: PCT/CN08/73861

§ 371 Date: Nov. 19, 2010

(30) Foreign Application Priority Data
May 22, 2008 (CN) 200810108521.3

(51) Int. Cl. H04W 4/00

(52) U.S. Cl. 370/338

(57) ABSTRACT

The present invention discloses a method for sending signaling and a method for receiving signaling in a multiple carrier frequency communication system. The method for sending signaling comprises: a base station sends control signaling on a primary carrier frequency corresponding to a terminal; the control signaling carries the indication information for indicating the part of control signaling which needs to be decoded of a secondary carrier frequency. The primary carrier frequency is a carrier frequency resource that the terminal must decode all the control signaling. The secondary carrier frequency is a carrier frequency resource on which the terminal can operate determined by the control signaling on the primary carrier frequency of the terminal, and whether the part of the control signaling of the secondary carrier frequency needs to be decoded is indicated by the control signaling of the primary carrier frequency.

### FIELD OF THE INVENTION

The present invention relates to communication field, in particular to a method for sending signaling and a method for receiving signaling in a multiple carrier frequency communication system.

### BACKGROUND OF THE INVENTION

In a wireless communication system, a base station refers to a device which provides service for a terminal. The base station communicates with the terminal through an uplink/downlink, wherein the downlink refers to a direction from the base station to the terminal, and the uplink refers to the direction from the terminal to the base station. Multiple terminals can send data to the base station at the same time through the uplink, and can also receive data from the base station at the same time through the downlink.

In general, in a data transmission system which is dispatched and controlled by the base station, all the control signaling of the system is sent to the terminal by the base station, such as the resource distribution situation when the base station performs a downlink transmission, and the situation of the resources used when the terminal performs an uplink transmission.

With the incessant improvement of the processing capacity of chips, more and more terminals can support simultaneous working under multiple carrier frequencies. In this case, the base station and the terminal perform information interaction through the multiple carrier frequencies. Generally speaking, the terminal needs to decode the control signaling on all the available carrier frequencies, and only in such a way can the resources distribution situation of the terminal and other useful control information be determined to realize the communication between the terminal and the base station.

Since not all the terminal is allocated to all the carrier frequency resources, if the terminal decodes the control signaling on all the available carrier frequencies every time, the power consumption of the terminal will be increased, the stand-by time of the terminal will be shortened, and thus the efficiency of the system will be influenced.

### SUMMARY OF THE PRESENT INVENTION

The present invention is provided aiming at the problem in the prior art that the terminal decoding the control signaling on all available carrier frequencies every time leads to the increase of power consumption of the terminal and the impact on the system efficiency. For this reason, the present invention aims at providing a method for sending signaling and a method for receiving signaling in the multiple carrier frequency communication system to solve at least one of the above-mentioned problems.

In order to achieve the above-mentioned aim, according to one aspect of the present invention, a method for sending signaling in the multiple carrier frequency communication system is provided.

In the method for sending signaling in a multiple carrier frequency communication system according to the present invention, a base station sends control signaling on a primary carrier frequency corresponding to a terminal; the control signaling carries the indication information for indicating a part of control signaling which needs to be decoded of a secondary carrier frequency. Wherein, the primary carrier frequency is the carrier frequency resource that the terminal must decode all the control signaling; the secondary carrier frequency is the carrier frequency resource on which the terminal can operate determined by the control signaling on the primary carrier frequency of the terminal, and whether the part of the control signaling on the secondary carrier frequency needs to be decoded is indicated by the control signaling on the primary carrier frequency.

According to another aspect of the present invention, the present invention provides a method for receiving signaling in the multiple carrier frequency communication system.

In the method for receiving signaling in a multiple carrier frequency communication system according to the present invention, a terminal receives control signaling sent by a base station on a primary carrier frequency of the terminal, wherein, the control signaling carries the indication information for indicating a part of control signaling which needs to be decoded of the secondary carrier frequency; the terminal obtains the indication information, and determines the secondary carrier frequency on which the part of control signaling needs to be decoded according to the indication information; the terminal decodes the part of the control signaling on the determined secondary carrier frequency; wherein, the primary carrier frequency is the carrier frequency resource that the terminal must decode all the control signaling; the secondary carrier frequency is the carrier frequency resource on which the terminal can operate determined by the control signaling on the primary carrier frequency of the terminal, and whether the part of the control signaling on the secondary carrier frequency needs to be decoded is indicated by the control signaling on the primary carrier frequency.

Preferably, in the above-mentioned method for receiving signaling, the indication information comprises a first indication information and a second indication information, wherein, the first indication information is used to indicate whether the terminal needs to decode the part of control signaling on the secondary carrier frequency; the second indication information is used to indicate the position on the secondary carrier frequency of the part of control signaling needs to be decoded.

Preferably, in the above-mentioned method for receiving signaling, the terminal is a terminal which supports simultaneous working under multiple carrier frequencies, or a group of terminal set which supports simultaneous working under multiple carrier frequencies.

According to another aspect of the present invention, the present invention also provides a method for receiving signaling in the multiple carrier frequency communication system.

In the method for receiving signaling in a multiple carrier frequency communication system according to the present invention, a terminal receives control signaling sent by a base station on a primary carrier frequency of the terminal, wherein, the control signaling carries the indication information for indicating a part of control signaling which needs to be decoded of the secondary carrier frequency; the terminal obtains the indication information, and determines the secondary carrier frequency which carries the description information of the part of control signaling according to the indication information, and determines whether the part of control signaling on the secondary carrier frequency changes according to the description information of the part of control signaling; for the secondary carrier frequency of which the part of control signaling has changed, the terminal decodes the changed part of the control signaling according to the indication information. Wherein, the primary carrier frequency is the carrier frequency resource on which the terminal must decode all the control signaling; the secondary carrier frequency is the carrier frequency resource on which the terminal can operate determined by the control signaling on the primary carrier frequency of the terminal, and whether the part of the control signaling on the secondary carrier frequency needs to be decoded is indicated by the control signaling on the primary carrier frequency.

Preferably, in the above-mentioned method for receiving signaling, the indication information comprises a first indication information and a second indication information, wherein, the first indication information is used to indicate the secondary carrier frequency which carries the description information of the part of control signaling; the second indication information is used to indicate the position on the secondary carrier frequency of the part of control signaling needs to be decoded.

Preferably, in the above-mentioned method for receiving signaling, the terminal is a terminal which supports simultaneous working under multiple carrier frequencies, or a group of terminal set which supports simultaneous working under multiple carrier frequencies.

According to another aspect of the present invention, the present invention provides a method for sending signaling in the multiple carrier frequency communication system.

In the method for sending signaling in a multiple carrier frequency communication system according to the present invention, a base station sends control signaling on a primary carrier frequency corresponding to a terminal, wherein, the control signaling carries the indication information for indicating the position on the primary carrier frequency of the part of control signaling which needs to be decoded of the secondary carrier frequency. Wherein, the primary carrier frequency is the carrier frequency resource that the terminal must decode all the control signaling; the secondary carrier frequency is the carrier frequency resource on which the terminal can operate determined by the control signaling on the primary carrier frequency of the terminal, and whether the part of the control signaling on the secondary carrier frequency needs to be decoded is indicated by the control signaling on the primary carrier frequency.

According to another aspect of the present invention, the present invention also provides a method for receiving signaling in the multiple carrier frequency communication system.

In the method for receiving signaling in a multiple carrier frequency communication system according to the present invention, a terminal receives control signaling sent by a base station on a primary carrier frequency of the terminal, wherein, the control signaling carries the indication information for indicating the position on the primary carrier frequency of the part of control signaling which needs to be decoded of the secondary carrier frequency; the terminal obtains the indication information, and determines the position on the primary carrier frequency of the part of control signaling related to the terminal on the secondary carrier frequency. Wherein, the primary carrier frequency is the carrier frequency resource that the terminal must decode all the control signaling; the secondary carrier frequency is the carrier frequency resource on which the terminal can operate determined by the control signaling on the primary carrier frequency of the terminal, and whether the part of the control signaling on the secondary carrier frequency needs to be decoded is indicated by the control signaling on the primary carrier frequency.

Preferably, in the above-mentioned method for receiving signaling, the terminal is a terminal which supports simultaneous working under multiple carrier frequencies, or a group of terminal set which supports simultaneous working under multiple carrier frequencies.

According to another aspect of the present invention, the present invention also provides a method for receiving signaling in the multiple carrier frequency communication system.

In the method for receiving signaling in a multiple carrier frequency communication system according to the embodiment of the present invention, a terminal receives control signaling sent by a base station on a primary carrier frequency of the terminal, wherein, the control signaling carries the indication information for indicating a part of control signaling which needs to be decoded of the secondary carrier frequency; the terminal obtains the indication information, determines the secondary carrier frequency which carries the description information of the part of control signaling according to the indication information, and determines whether the part of control signaling on the secondary carrier frequency changes according to the description information of the part of control signaling; for the secondary carrier frequency of which the part of control signaling has changed, the terminal determines the position on the primary carrier frequency of the changed part of the control signaling according to the indication information. Wherein, the primary carrier frequency is the carrier frequency resource that the terminal must decode all the control signaling; the secondary carrier frequency is the carrier frequency resource on which the terminal can operate determined by the control signaling on the primary carrier frequency of the terminal, and whether the part of the control signaling on the secondary carrier frequency needs to be decoded is indicated by the control signaling on the primary carrier frequency.

Preferably, in the above-mentioned method for receiving signaling, the indication information comprises a first indication information and a second indication information, wherein, the first indication information is used to indicate the secondary carrier frequency which carries the description information of the part of control signaling; the second indication information is used to indicate the position on the primary carrier frequency of the changed part of the control signaling on the secondary carrier frequency.

Preferably, in the above-mentioned method for receiving signaling, the terminal is a terminal which supports simultaneous working under multiple carrier frequencies, or a group of terminal set which supports simultaneous working under multiple carrier frequencies.

According to another aspect of the present invention, the present invention also provides a method for sending signaling in the multiple carrier frequency communication system.

In the method for receiving signaling in a multiple carrier frequency communication system according to the present invention, the method for sending signaling comprises: a base station sends control signaling on a primary carrier frequency corresponding to a terminal, wherein, the control signaling carries the indication information for indicating the part of control signaling which needs to be decoded of the secondary carrier frequency. Wherein, the terminal is a terminal which supports simultaneous working under multiple carrier frequencies, or a group of terminal set which supports simultaneous working under multiple carrier frequencies.

According to another aspect of the present invention, the present invention also provides a method for receiving signaling in the multiple carrier frequency communication system.

In the method for receiving signaling in a multiple carrier frequency communication system according to the present invention, the method for receiving signaling comprises: a terminal receives control signaling sent by a base station on a primary carrier frequency of the terminal, wherein, the control signaling carries the indication information for indicating the part of control signaling which needs to be decoded of the secondary carrier frequency; the terminal obtains the indication information, and determines the secondary carrier frequency on which the part of control signaling needs to be decoded according to the indication information; the terminal decodes the part of the control signaling on the determined secondary carrier frequency.

According to another aspect of the present invention, the present invention also provides a method for receiving signaling in the multiple carrier frequency communication system.

In the method for receiving signaling in a multiple carrier frequency communication system according to the present invention, the method for receiving signaling comprises: a terminal receives control signaling sent by a base station on a primary carrier frequency of the terminal, wherein, the control signaling carries the indication information for indicating the part of control signaling which needs to be decoded of the secondary carrier frequency; the terminal obtains the indication information, determines the secondary carrier frequency which carries the description information of the part of control signaling according to the indication information, and determines whether the part of control signaling on the secondary carrier frequency changes according to the description information of the part of control signaling; for the secondary carrier frequency of which the part of control signaling has changed, the terminal decodes the changed part of control signaling according to the indication information.

According to another aspect of the present invention, the present invention also provides a method for sending signaling in the multiple carrier frequency communication system.

In the method for sending signaling in a multiple carrier frequency communication system according to the present invention, the method for sending signaling comprises: a base station sends control signaling on a primary carrier frequency corresponding to a terminal, wherein, the control signaling carries the indication information for indicating the position on the primary carrier frequency of the control signaling which needs to be decoded of the secondary carrier frequency.

According to another aspect of the present invention, the present invention also provides a method for receiving signaling in the multiple carrier frequency communication system.

In the method for receiving signaling in a multiple carrier frequencies communication system according to the present invention, the method for receiving signaling comprises: a terminal receives control signaling sent by a base station on a primary carrier frequency of the terminal, wherein, the control signaling carries the indication information for indicating the position on the primary carrier frequency of the part of control signaling which needs to be decoded of the secondary carrier frequency; the terminal obtains the indication information, and determines the position on the primary carrier frequency of the part of control signaling related to the terminal on the secondary carrier frequency.

According to another aspect of the present invention, the present invention further provides a method for receiving signaling in the multiple carrier frequency communication system.

In the method for receiving signaling in a multiple carrier frequency communication system according to the present invention, the method for receiving signaling comprises: a terminal receives control signaling sent by a base station on a primary carrier frequency of the terminal, wherein, the control signaling carries the indication information for indicating the part of control signaling which needs to be decoded of the secondary carrier frequency; the terminal obtains the indication information, determines the secondary carrier frequency which carries the description information of the part of control signaling according to the indication information, and determines whether the part of control signaling on the secondary carrier frequency changes according to the description information of the part of control signaling; for the secondary carrier frequency of which the part of control signaling has changed, the terminal determines the position on the primary carrier frequency of the changed part of control signaling according to the indication information.

According to another aspect of the present invention, the present invention also provides a method for sending signaling in the multiple carrier frequency communication system.

The method for sending signaling according to the present invention comprises: a base station indicates a terminal a part of control signaling which needs to be decoded of secondary carrier frequencies through sending control signaling on a primary carrier frequency corresponding to the terminal. Wherein, the terminal is a terminal which supports simultaneous working under multiple carrier frequencies, or a group of terminal set which supports simultaneous working under multiple carrier frequencies.

In virtue of at least one of the above-mentioned technical schemes, through decoding the control signaling on the secondary carrier frequency related to the terminal only, compared with the prior art, the present invention can overcome the problem that the power consumption of the terminal increases because the terminal decodes the control signaling on all available carrier frequencies every time, and thus can reduce the power consumption of the terminal.

### BRIEF DESCRIPTION OF THE DRAWINGS

The drawings in the specification provide a further understanding to the present invention and constitute a part of the application. The exemplary embodiments of the present invention and the explanation thereof are given by way of illustration only, and thus are not limitative of the present invention, and wherein:

FIG. 1 is a flowchart of signaling indication method in a multiple carrier frequency communication system according to the first embodiment of the present invention;

FIG. 2 is a schematic diagram of the system frame structure according to the first embodiment of the present invention;

FIG. 3 is a detailed processing flowchart of signaling indication method in a multiple carrier frequency communication system according to the first embodiment of the present invention;

FIG. 4 is a flowchart of signaling indication method in a multiple carrier frequency communication system according to the second embodiment of the present invention;

FIG. 5 is a schematic diagram of the system frame structure according to the second embodiment of the present invention;

FIG. 6 is a detailed processing flowchart of signaling indication method in a multiple carrier frequency communication system according to the second embodiment of the present invention;

FIG. 7 is a flowchart of signaling indication method in a multiple carrier frequency communication system according to the third embodiment of the present invention;

FIG. 8 is a schematic diagram of the system frame structure according to the third embodiment of the present invention;

FIG. 9 is a detailed processing flowchart of signaling indication method in a multiple carrier frequency communication system according to the third embodiment of the present invention;

FIG. 10 is a flowchart of signaling indication method in a multiple carrier frequency communication system according to the fourth embodiment of the present invention;

FIG. 11 is a schematic diagram of the system frame structure according to the fourth embodiment of the present invention;

FIG. 12 is a detailed processing flowchart of signaling indication method in a multiple carrier frequency communication system according to the fourth embodiment of the present invention;

### DETAILED DESCRIPTION

### General Description of Functions

In the technical schemes provided by the embodiments of the present invention, through decoding the control signaling on the secondary carrier frequency related to the terminal only, the effect of reducing the power consumption of the terminal can be achieved. That is to say, a terminal receives control signaling sent by a base station on a primary carrier frequency of the terminal, wherein the control signaling carries indication information for indicating a part of control signaling which needs to be decoded of the secondary carrier frequency; the terminal obtains the indication information, and determines the secondary carrier frequency of which the part of control signaling needs to be decoded according to the indication information; the terminal decodes the part of the control signaling on the determined secondary carrier frequency. Compared with the prior art, the present invention can overcome the problem that the power consumption of the terminal increases because the terminal decodes the control signaling on all available carrier frequencies every time.

The present invention will be explained in detail hereinafter in conjunction with the drawings and the embodiments. What needs to be explained is, if there is no conflict, the embodiments of the present invention and the characters in it can be combined with each other.

The primary carrier frequency mentioned in the present invention is the carrier frequency resource that the terminal must decode all the control signaling; the secondary carrier frequency is the carrier frequency resource on which the terminal can operate determined by the control signaling on the primary carrier frequency of the terminal, and whether the part of the control signaling on the secondary carrier frequency needs to be decoded is indicated by the control signaling on the primary carrier frequency. The terminal mentioned hereinafter can be a terminal which supports simultaneous working under multiple carrier frequencies, or a group of terminal set which supports simultaneous working under multiple carrier frequencies. All the control signaling mentioned above is all the control signaling related to one terminal or a group of terminals.

### The First Method Embodiment

The present invention provides a method for sending signaling in a multiple carrier frequency communication system according to the embodiment of the present invention.

In the method for sending signaling in a multiple carrier frequency communication system according to the embodiment of the present invention, a base station sends control signaling on a primary carrier frequency corresponding to a terminal, and the control signaling carries the indication information for indicating the part of control signaling which needs to be decoded of the secondary carrier frequency.

The present invention also provides a method for receiving signaling in a multiple carrier frequency communication system according to the embodiment of the present invention.

The method for receiving signaling in a multiple carrier frequency communication system according to the embodiment of the present invention comprises the following steps: a terminal receives control signaling sent by a base station on a primary carrier frequency of the terminal, wherein the control signaling carries the indication information for indicating a part of control signaling which needs to be decoded of the secondary carrier frequency; the terminal obtains the indication information, and determines the secondary carrier frequency of which the part of control signaling needs to be decoded according to the indication information; the terminal decodes the part of the control signaling on the determined secondary carrier frequency.

Further, in the above-mentioned method for receiving signaling, the indication information comprises a first indication information and a second indication information, wherein the first indication information is used to indicate whether the terminal needs to decode the part of control signaling on the secondary carrier frequency; the second indication information is used to indicate the position on the secondary carrier frequency of which the part of control signaling needs to be decoded. In this case, the terminal can firstly judge whether the part of control signaling on the secondary carrier frequency needs to be decoded according to the first indication information; under the circumstance that the judgment result is yes, the terminal then judges the position on the secondary carrier frequency of the part of control signaling needs to be decoded.

In conjunction with the above-mentioned methods for sending and receiving signaling in a multiple carrier frequency communication system, the signaling indication method in a multiple carrier frequency communication system provided by the present invention will be described hereafter with reference to the drawings.

FIG. 1 is a flowchart of signaling indication method in a multiple carrier frequency communication system according to the first embodiment of the present invention. The method is a method that in a multiple carrier frequency wireless communication system, a terminal M with simultaneous working ability under multiple carrier frequencies obtains the part of control signaling on multiple carrier frequencies. Supposing that the terminal M knows which carrier frequencies are the primary carrier frequency for the terminal M (the terminal M needs to decode the control signaling on these carrier frequencies to obtain the relevant control signaling situation of the terminal M on all the carrier frequencies), and which carrier frequencies are the secondary carrier frequency for the terminal M (the terminal M does not need to decode all the control signaling on these carrier frequencies), as shown in FIG. 1, the flow comprises the steps as follows (step S102-step S104):

Step S102, a base station sends the control signaling to terminal M on the primary carrier frequency of the terminal M through a downlink channel; the control signaling at least comprises the information for indicating whether the terminal M needs to decode the part of control signaling of the secondary carrier frequency, and the position information on the secondary carrier frequency of the part of control signaling needs to be decoded and etc.

Wherein, the control signaling sent on the primary carrier frequency at least comprises the signaling formats as shown in Table 1:

TABLE 1
Control Signaling Format

| Syntax | Notes |
|---|---|
| { | |
| Terminal identifier | The identifier of terminal which can work under multiple carrier |
| | frequencies at the same time |
| Secondary carrier | The bit length equals to the number of the secondary carrier |
| frequency indication | frequency of the terminal, wherein each bit corresponds to one |
| BITMAP | secondary carrier frequency. The number “1” means the terminal |
| | indicated by the terminal identifier needs to decode the part of control |
| | signaling on the secondary carrier frequency; and the number “0” |
| | means the terminal indicated by the terminal identifier does not need |
| | to decode the control signaling on the secondary carrier frequency. |
| for(i=0;i<sum(BITM | Sum (BITMAP= =1) is the total number of the secondary carrier |
| AP= =1); i++) | frequencies corresponding to the control signaling which needs to be |
| | decoded by the terminal indicated by the terminal identifier. |
| { | |
| The number of control | The number of the control signaling which needs to be decoded of the |
| signaling | secondary carrier frequency. |
| for(j=0;j<the number | The position information on the secondary carrier frequency of |
| of control signaling; | different types of control signaling |
| j++) | |
| { | |
| Address_j; | |
| } | |
| } | |
| . . . | |
| } | |

Step S104, after receiving the control signaling on the primary carrier frequency successfully, the terminal M first determines the secondary carrier frequency of which the part of the control signaling needs to be decoded, and then decodes the part of control signaling on the secondary carrier frequency.

In the embodiment, through decoding the control signaling on the secondary carrier frequency related to the terminal only, compared with the prior art, the present invention overcomes the problem that the power consumption of the terminal increases because the terminal decodes the control signaling on all available carrier frequencies every time, reduces the power consumption of the terminal, prolongs the stand-by time of the terminal, and improves the efficiency of the system.

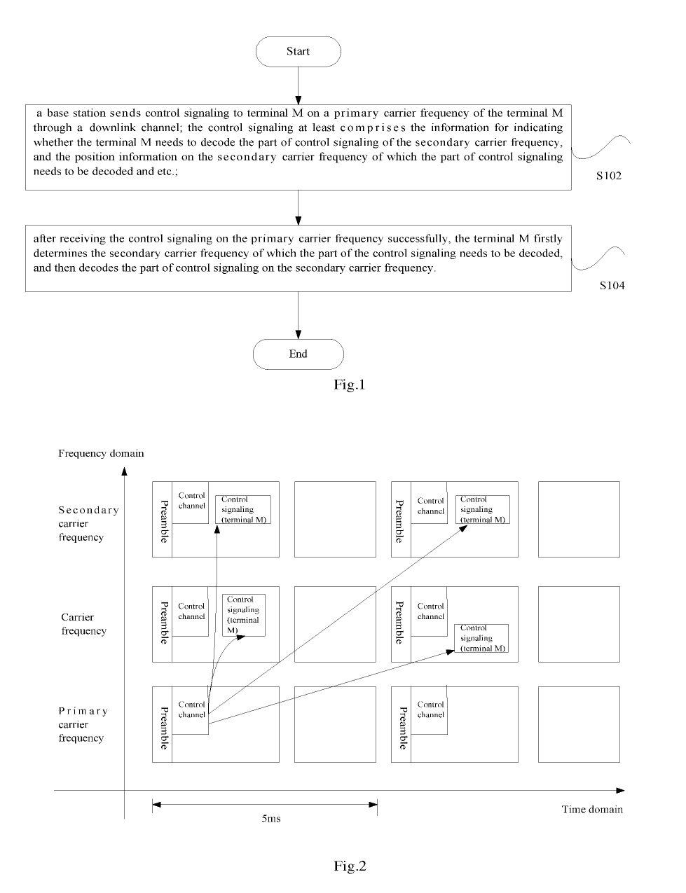

FIG. 2 is a schematic diagram of the system frame structure according to the first embodiment of the present invention. FIG. 2 shows a detailed embodiment of the method provided by the present invention in the wireless communication system which uses time division duplexing (TDD) mode. As shown in FIG. 2, three carrier frequencies RF1, RF2 and RF3 are included; the wireless frame is 5 ms in length; each frame comprises a preamble, a control channel and etc.; wherein control channels of RF1, RF2 and RF3 are sent in the same time period. Supposing that the carrier frequency RF1 is the primary carrier frequency, and the carrier frequency RF2 and carrier frequency RF3 are the secondary carrier frequencies for the terminal M which can work on the carrier frequency RF1, carrier frequency RF2 and carrier frequency RF3 at the same time, the signaling indication method of the embodiment will be detailed hereafter in conjunction with FIG. 3.

FIG. 3 is a detailed processing flowchart of signaling indication method in a multiple carrier frequency communication system according to the first embodiment of the present invention. As shown in FIG. 3, the flow comprises the steps as follows (step S302-step S306):

Step S302, a base station sends control signaling to terminal M on the primary carrier frequency RF1 of the terminal M through a downlink channel;

Step S304, after receiving the control signaling of the primary carrier frequency successfully, the terminal M determines the secondary carrier frequency of which the part of the control signaling needs to be decoded through decoding the secondary carrier frequency indication BITMAP. In the embodiment, supposing that the RF2 and RF3 both have the part of control signaling related to the terminal M, then the secondary carrier frequency indication BITMAP equals to 11. If only the RF2 has the part of control signaling related to the terminal M, then the secondary carrier frequency indication BITMAP equals to 01. If only the RF3 has the part of control signaling related to the terminal M, then the secondary carrier frequency indication BITMAP equals to 10. If the RF2 and RF3 neither have the part of control signaling related to the terminal M, then the secondary carrier frequency indication BITMAP equals to 00.

Step S306, after determining the secondary carrier frequency information of which the part of control signaling needs to be decoded, the terminal M obtains the position information on the secondary carrier frequency of the part of control signaling through the position information bit address on the primary carrier frequency of the part of control signaling on the secondary carrier frequency, and then decodes the part of control signaling on the secondary carrier frequency.

### The Second Embodiment

The present invention provides a method for sending signaling in a multiple carrier frequency communication system according to the embodiment of the present invention.

In the method for sending signaling in a multiple carrier frequency communication system according to the embodiment of the present invention, a base station sends control signaling on a primary carrier frequency corresponding to a terminal, and the control signaling carries the indication information for indicating the part of control signaling which needs to be decoded of the secondary carrier frequency.

The present invention also provides a method for receiving signaling in a multiple carrier frequency communication system according to the embodiment of the present invention.

The method for receiving signaling in a multiple carrier frequency communication system according to the embodiment of the present invention comprises the following processing: a terminal receives the control signaling sent by a base station on a primary carrier frequency of the terminal, wherein the control signaling carries the indication information for indicating the part of control signaling which needs to be decoded of the secondary carrier frequency; the terminal obtains the indication information, determines the secondary carrier frequency which carries the description information of the part of control signaling according to the indication information, and determines whether the part of control signaling on the secondary carrier frequency changes according to the description information of the part of control signaling; for the secondary carrier frequency of which the part of control signaling has changed, the terminal decodes the changed part of control signaling according to the indication information.

Further, in the above-mentioned method for receiving signaling, the indication information comprises a first indication information and a second indication information, wherein the first indication information is used to indicate the secondary carrier frequency which carries the description information of the part of control signaling; the second indication information is used to indicate the position on the secondary carrier frequency of which the part of control signaling needs to be decoded. In this case, the terminal firstly determines the secondary carrier frequency which carries the description information of the part of control signaling according to the first indication information, then determines whether the part of control signaling on the secondary carrier frequency changes according to the description information of the part of control signaling; for the secondary carrier frequency of which the part of control signaling has changed, the terminal judges the position on the secondary carrier frequency of the changed part of control signaling according to the second indication information.

In conjunction with the above-mentioned methods for sending and receiving signaling in a multiple carrier frequency communication system, the signaling indication method in a multiple carrier frequency communication system provided by the embodiment of the present invention will be described hereafter with the drawings.

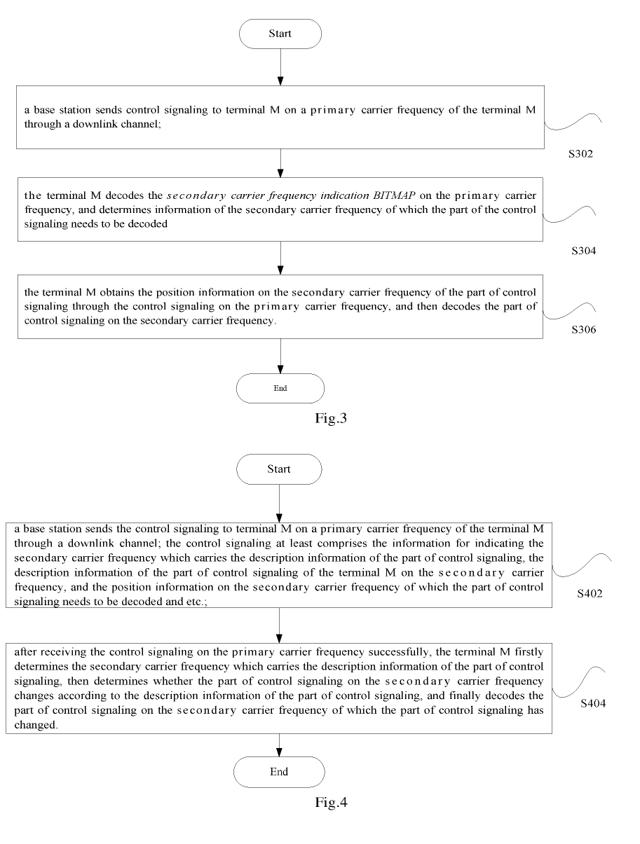

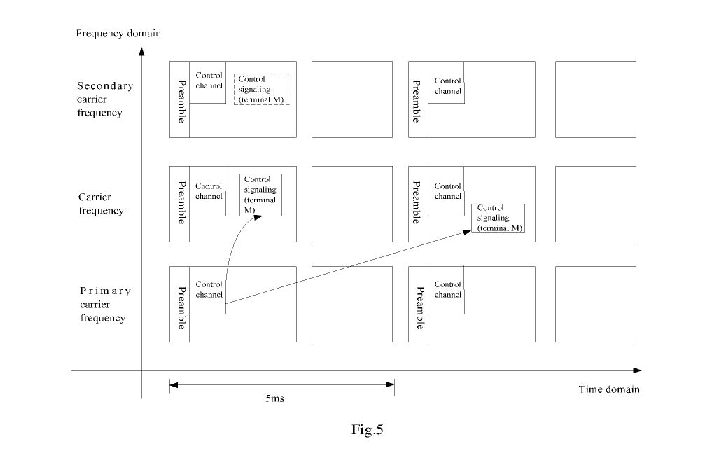

FIG. 4 is a flowchart of signaling indication method in a multiple carrier frequency communication system according to the second embodiment of the present invention. The method is a method that in a multiple carrier frequency wireless communication system, the terminal M with simultaneous working ability under multiple carrier frequencies obtains the situation of the part of control signaling on multiple carrier frequencies. Supposing that the terminal M knows which carrier frequencies are the primary carrier frequency for the terminal M (the terminal M needs to decode the control signaling on these carrier frequencies to obtain the relevant control signaling situation of the terminal M on all the carrier frequencies), and which carrier frequencies are the secondary carrier frequency for the terminal M (the terminal M does not need to decode all the control signaling on these carrier frequencies), as shown in FIG. 4, the flow comprises the steps as follows (step S402-step S404):

Step S402, a base station sends a control signaling to terminal M on a primary carrier frequency of the terminal M through a downlink channel; the control signaling at least comprises the information for indicating the secondary carrier frequency which carries the description information of the part of control signaling, the description information of the part of control signaling of the terminal M on the secondary carrier frequency, and the position information on the secondary carrier frequency of which the part of control signaling needs to be decoded and etc.

Wherein, the control signaling sent on the primary carrier frequency at least comprises the signaling formats as shown in Table 2:

TABLE 2
Control Signaling Format

| Syntax | Notes |
|---|---|
| { | |
| Terminal identifier | The identifier of terminal which can work under multiple carrier |
| | frequencies at the same time |
| Secondary carrier | The bit length equals to the number of the secondary carrier |
| frequency indication | frequency of the terminal, wherein each bit corresponds to one |
| BITMAP | secondary carrier frequency. The number “1” means that the |
| | description information related to the control signaling of the |
| | secondary carrier frequency will be carried subsequently; the number |
| | “0” means that the description information related to the control |
| | signaling of the secondary carrier frequency will not be carried |
| | subsequently. |
| for(i=0;i<sum(BITM | Sum (BITMAP= =1) is the total number of the secondary carrier |
| AP= =1); i++) | frequencies which carries the description information of the part of |
| | control signaling. |
| { | |
| The number of | The number of the control signaling related to the terminal M. |
| counter fields | |
| for(j=0; j<the number | The description information about the variation of different types of |
| of counter fields; j++) | control signaling on the secondary carrier frequency. The terminal |
| { | compares the Counter values of the same type control signaling |
| Counter_ j; | between the two moments before and after receiving the signaling. If |
| Address_j; | the two values are same, the type of control signaling does not change |
| } | and the control signaling does not need to be decoded; otherwise, the |
| } | position information Address on the secondary carrier frequency of |
| | the part of control signaling needs to be decoded. |
| . . . | |
| } | |

Step S404, after receiving the control signaling on the primary carrier frequency successfully, the terminal M firstly determines the secondary carrier frequency which carries the description information of the part of control signaling, then determines whether the part of control signaling on the secondary carrier frequency changes according to the description information of the part of control signaling, and finally decodes the part of control signaling on the secondary carrier frequency of which the part of control signaling has changed.

In the embodiment, through decoding the control signaling on the secondary carrier frequency related to the terminal only, compared with the prior art, the present invention overcomes the problem that the power consumption of the terminal increases because the terminal decodes the control signaling on all available carrier frequencies every time, reduces the power consumption of the terminal, prolongs the stand-by time of the terminal, and improves the efficiency of the system.

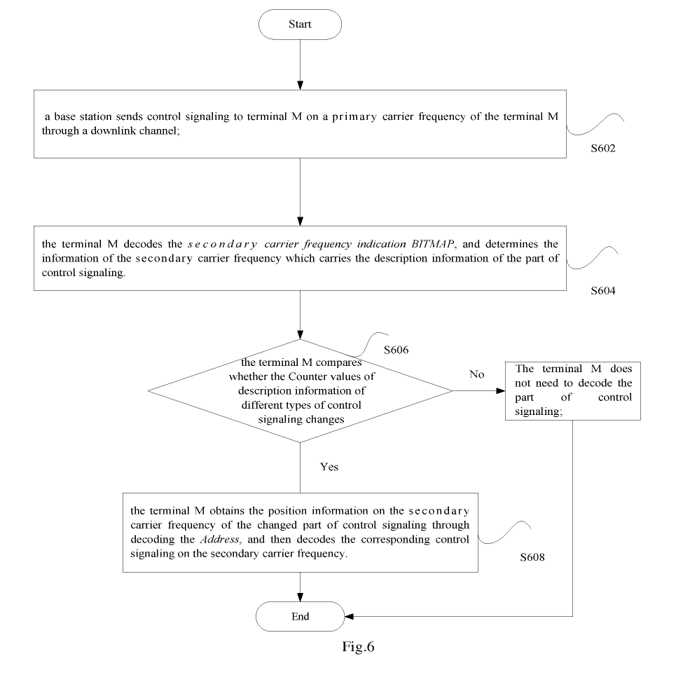

FIG. 5 is a schematic diagram of the system frame structure according to the second embodiment of the present invention. FIG. 5 shows another detailed embodiment of the method provided by the present invention in the wireless communication system which uses time division duplexing (TDD) mode. As shown in FIG. 5, three carrier frequencies RF1, RF2 and RF3 are included; the wireless frame is 5ms in length; each frame comprises a preamble, a control channel and etc.; wherein control channels of RF1, RF2 and RF3 are sent in the same time period. Supposing that the carrier frequency RF1 is the primary carrier frequency, and the carrier frequency RF2 and carrier frequency RF3 are the secondary carrier frequencies for the terminal M which can work on the carrier frequency RF1, carrier frequency RF2 and carrier frequency RF3 at the same time, the signaling indication method of the embodiment will be detailed hereafter in conjunction with FIG. 6.

FIG. 6 is a detailed processing flowchart of signaling indication method in a multiple carrier frequency communication system according to the second embodiment of the present invention. As shown in FIG. 6, the flow comprises the steps as follows (step S602-step S608):

Step S602, a base station sends control signaling to terminal M on a primary carrier frequency RF1 of the terminal M through a downlink channel;

Step S604, after receiving the control signaling of the primary carrier frequency successfully, the terminal M determines the secondary carrier frequency which carries the description information of the part of control signaling through decoding the secondary carrier frequency indication BITMAP. In the embodiment, supposing that the RF2 and RF3 both have the part of control signaling related to the terminal M, then the secondary carrier frequency indication BITMAP equals to 11. If only the RF2 has the part of control signaling related to the terminal M, then the secondary carrier frequency indication BITMAP equals to 01. If only the RF3 has the part of control signaling related to the terminal M, then the secondary carrier frequency indication BITMAP equals to 10. If the RF2 and RF3 neither have the part of control signaling related to the terminal M, then the secondary carrier frequency indication BITMAP equals to 00.

Step S606, after determining the secondary carrier frequency which carries the description information of the part of control signaling, in the control signaling of the primary carrier frequency, the terminal M determines whether the part of control signaling information on the corresponding secondary carrier frequency changes through comparing whether the Counter values of description information of different types of control signaling change. As shown in FIG. 5, in the embodiment, supposing that the part of control signaling of the terminal M on the secondary carrier frequency RF3 does not change (as the dotted rectangle shown in FIG. 5), then the Counter value maintains the original value unchanged, e.g. Counter_{—}1=1 (the original value of Counter_{—}1 is 1); while on the secondary carrier frequency RF2, part of subsequent control signaling changes (as the solid rectangle shown in FIG. 5), then the corresponding Counter value changes, e.g. Counter_{—}1=2 (the original value of Counter_{—}1 is 1). Therefore, through comparing the Counter values on a secondary carrier frequency before and after receiving the signaling on the primary carrier frequency, the terminal M knows which type of control signaling (the changed control signaling) needs to be decoded, instead of decoding the control signaling of all secondary carrier frequencies. Consequently, the power consumption of the terminal is reduced; the stand-by time of the terminal is prolonged; and the efficiency of the system is improved.

Step S608, the terminal M obtains the position information on the secondary carrier frequency of the part of control signaling through decoding the position information bit address on the primary carrier frequency of the changed control signaling on the secondary carrier frequency, and then decodes the corresponding control signaling on the secondary carrier frequency.

### The Third Method Embodiment

The present invention provides a method for sending signaling in a multiple carrier frequency communication system according to the embodiment of the present invention.

In the method for sending signaling in a multiple carrier frequency communication system according to the embodiment of the present invention, a base station sends control signaling on a primary carrier frequency corresponding to a terminal, wherein the control signaling carries the indication information for indicating the position on the primary carrier frequency of the control signaling which needs to be decoded of the secondary carrier frequency.

The present invention also provides a method for receiving signaling in a multiple carrier frequency communication system according to the embodiment of the present invention.

The method for receiving signaling in a multiple carrier frequency communication system according to the embodiment of the present invention comprises the following steps: a terminal receives a control signaling sent by a base station on a primary carrier frequency of the terminal, wherein the control signaling carries the indication information for indicating the position on the primary carrier frequency of the part of control signaling which needs to be decoded of the secondary carrier frequency; the terminal obtains the indication information, and determines the position on the primary carrier frequency of the part of control signaling related to the terminal on the secondary carrier frequency.

In conjunction with the above-mentioned methods for sending and receiving signaling in a multiple carrier frequency communication system, the signaling indication method in a multiple carrier frequency communication system provided by the embodiment of the present invention will be described hereafter with reference to the drawings.

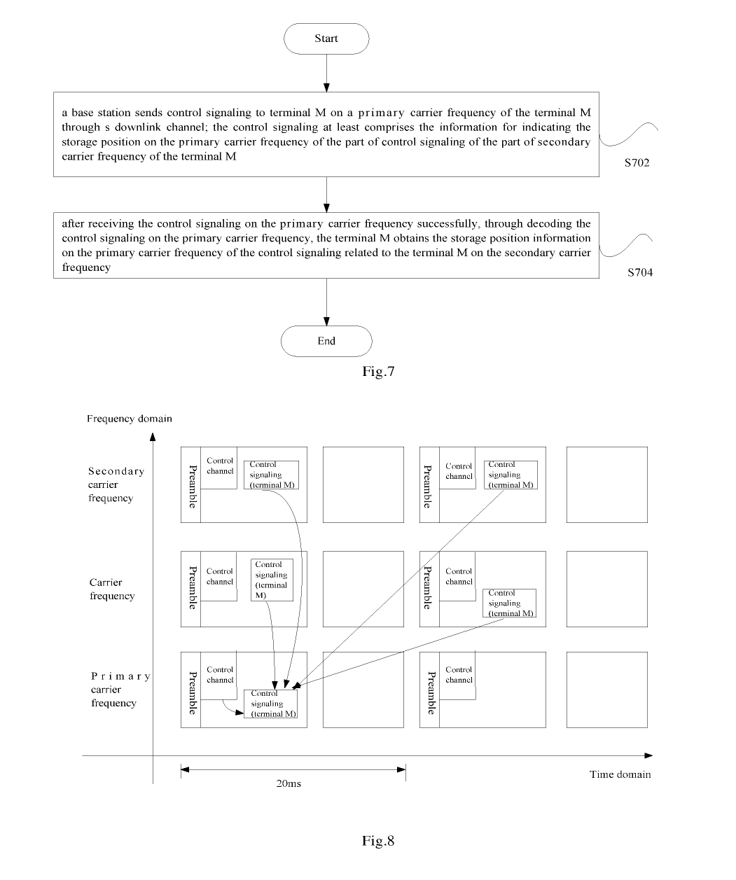

FIG. 7 is a flowchart of signaling indication method in a multiple carrier frequency communication system according to the third embodiment of the present invention. The method is a method that in a multiple carrier frequency wireless communication system, the terminal M with simultaneous working ability under multiple carrier frequencies obtains the situation of the part of control signaling on multiple carrier frequencies. Supposing that the terminal M knows which carrier frequencies are the primary carrier frequency for the terminal M (the terminal M needs to decode the control signaling on these carrier frequencies to obtain the relevant control signaling situation of the terminal M on all the carrier frequencies), and which carrier frequencies are the secondary carrier frequency for the terminal M (the terminal M does not need to decode all the control signaling on these carrier frequencies), as shown in FIG. 7, the flow comprises the steps as follows (step S702-step S704):

Step S702, a base station sends control signaling to terminal M on a primary carrier frequency of the terminal M through a downlink channel; the control signaling at least comprises the information for indicating the storage position on the primary carrier frequency of the part of control signaling of the secondary carrier frequency of the terminal M.

Wherein, the control signaling sent on the primary carrier frequency at least comprises the signaling formats as shown in table 3:

TABLE 3
Control Signaling Format

| Syntax | Notes |
|---|---|
| { | |
| Terminal identifier | The identifier of terminal which can work under multiple carrier |
| | frequencies at the same time |
| Secondary carrier | The bit length equals to the number of the secondary carrier |
| frequency indication | frequency of the terminal, wherein each bit corresponds to one |
| BITMAP | secondary carrier frequency. The number “1” means the terminal has |
| | the secondary carrier frequency with the part of control signaling; the |
| | number “0”means the terminal does not have the secondary carrier |
| | frequency with the part of control signaling. |
| for(i=0;i<sum(BITM | Sum (BITMAP= =1) is the total number of the secondary carrier |
| AP= =1); i++) | frequencies with the part of control signaling related to the terminal |
| | M. |
| { | |
| The number of control | The number of the control signaling related to the terminal M on the |
| signaling | secondary carrier frequency. |
| for(j=0;j<the number | The storage position information on the primary carrier frequency of |
| of control signaling; | the control signaling related to the terminal M on the secondary |
| j++) | carrier frequency. |
| { | |
| Address_j; | |
| } | |
| } | |
| . . . | |
| } | |

Step S704, after receiving the control signaling on the primary carrier frequency successfully, through decoding the control signaling on the primary carrier frequency, the terminal M obtains the storage position information on the primary carrier frequency of the control signaling related to the terminal M on the secondary carrier frequency.

In the embodiment, through decoding the control signaling on the primary carrier frequency related to the terminal only, compared with the prior art, the present invention overcomes the problem that the power consumption of the terminal increases because the terminal decodes the control signaling on all available carrier frequencies every time, reduces the power consumption of the terminal, prolongs the stand-by time of the terminal, and improves the efficiency of the system.

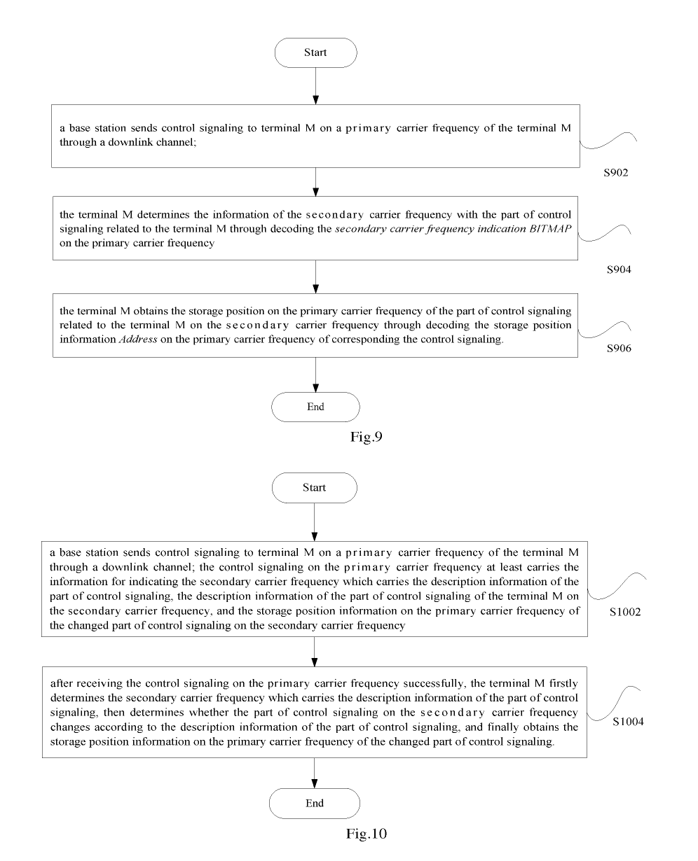

FIG. 8 is a schematic diagram of the system frame structure according to the third embodiment of the present invention. FIG. 2 shows another detailed embodiment of the method provided by the present invention in the wireless communication system which uses time division duplexing (TDD) mode. As shown in FIG. 8, three carrier frequencies RF1, RF2 and RF3 are included; the wireless super-frame is 20ms in length; each super-frame comprises a preamble, a control channel and etc.; wherein control channels of RF1, RF2 and RF3 are sent in the same time period. Supposing that the carrier frequency RF1 is the primary carrier frequency, and the carrier frequency RF2 and carrier frequency RF3 are the secondary carrier frequencies for the terminal M which can work on the carrier frequency RF1, carrier frequency RF2 and carrier frequency RF3 at the same time, the signaling indication method of the embodiment will be detailed in conjunction with FIG. 9.

FIG. 9 is a detailed processing flowchart of signaling indication method in a multiple carrier frequency communication system according to the third embodiment of the present invention. As shown in FIG. 9, the flow comprises the steps as follows (step S902-step S906):

Step S902, a base station sends control signaling to terminal M on a primary carrier frequency RF1 of the terminal M through a downlink channel;

Step S904, after receiving the control signaling of the primary carrier frequency successfully, the terminal M determines the secondary carrier frequency with the part of control signaling related to the terminal M through decoding the secondary carrier frequency indication BITMAP. In the embodiment, supposing that the RF2 and RF3 both have the part of control signaling related to the terminal M, then the secondary carrier frequency indication BITMAP equals to 11. If only the RF2 has the part of control signaling related to the terminal M, then the secondary carrier frequency indication BITMAP equals to 01. If only the RF3 has the part of control signaling related to the terminal M, then the secondary carrier frequency indication BITMAP equals to 10. If the RF2 and RF3 neither have the part of control signaling related to the terminal M, then the secondary carrier frequency indication BITMAP equals to 00.

Step S906, after determining the secondary carrier frequency with the part of control signaling related to the terminal M, through decoding the storage position information Address on the primary carrier frequency of the control signaling, the terminal M obtains the storage position on the primary carrier frequency of the part of control signaling related to the terminal M on the secondary carrier frequency. As shown in FIG. 8, the control signaling (the terminal M) in the RF2 and RF3 are both stored in the control signaling (the terminal M) of the primary carrier frequency RF1; and the Address signaling on the primary carrier frequency RF1 is used to indicate the storage position information of the part of control signaling on the primary carrier frequency.

### The Fourth Embodiment

The present invention provides a method for sending signaling in a multiple carrier frequency communication system according to the embodiment of the present invention.

In the method for sending signaling in a multiple carrier frequency communication system according to the embodiment of the present invention, a base station sends control signaling on a primary carrier frequency corresponding to the terminal, and the control signaling carries the indication information for indicating the position on the primary carrier frequency of the part of control signaling which needs to be decoded of the secondary carrier frequency.

The present invention also provides a method for receiving signaling in a multiple carrier frequency communication system according to the embodiment of the present invention.

The method for receiving signaling in a multiple carrier frequency communication system according to the embodiment of the present invention comprises the following steps: a terminal receives control signaling sent by a base station on a primary carrier frequency of the terminal, wherein the control signaling carries the indication information for indicating the part of control signaling which needs to be decoded of the secondary carrier frequency; the terminal obtains the indication information, determines the secondary carrier frequency which carries the description information of the part of control signaling according to the indication information, and determines whether the part of control signaling on the secondary carrier frequency changes according to the description information of the part of control signaling; for the secondary carrier frequency of which the part of control signaling has changed, the terminal determines the position on the primary carrier frequency of the changed part of control signaling according to the indication information.

Further, in the above-mentioned method for receiving signaling, the indication information comprises a first indication information and a second indication information, wherein the first indication information is used to indicate the secondary carrier frequency which carries the description information of the part of control signaling; the second indication information is used to indicate the position on the primary carrier frequency of the changed part of control signaling which needs to be decoded of the secondary carrier frequency. In this case, the terminal firstly determines the secondary carrier frequency which carries the description information of the part of control signaling according to the first indication information, then determines whether the part of control signaling on the secondary carrier frequency changes according to the description information of the part of control signaling; for the secondary carrier frequency of which the part of control signaling has changed, the terminal determines the position on the primary carrier frequency of the changed part of control signaling according to the second indication information.

In conjunction with the above-mentioned methods for sending and receiving signaling in a multiple carrier frequency communication system, the signaling indication method in a multiple carrier frequency communication system provided by the embodiment of the present invention will be described hereafter with the drawings.

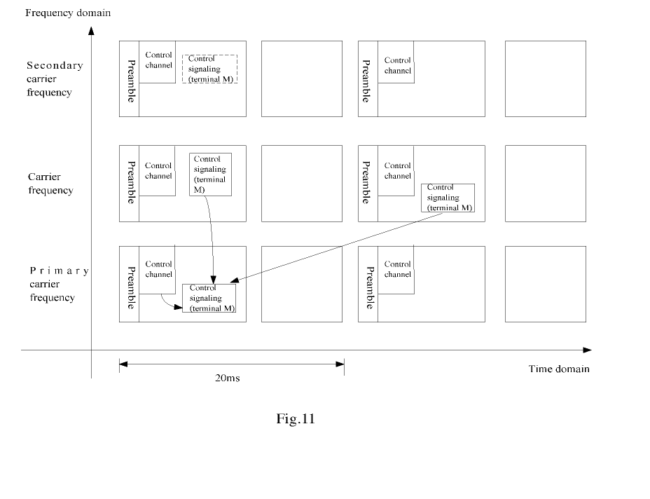

FIG. 10 is a flowchart of signaling indication method in a multiple carrier frequency communication system according to the fourth embodiment of the present invention. The method is a method that in a multiple carrier frequency wireless communication system, the terminal M with simultaneous working ability under multiple carrier frequencies obtains the situation of the part of control signaling on multiple carrier frequencies. Supposing that the terminal M knows which carrier frequencies are the primary carrier frequency for the terminal M (the terminal M needs to decode the control signaling on these carrier frequencies to obtain the relevant control signaling situation of the terminal M on all the carrier frequencies), and which carrier frequencies are the secondary carrier frequency for the terminal M (the terminal M does not need to decode all the control signaling on these carrier frequencies), as shown in FIG. 10, the flow comprises the steps as follows (step S1002-step S1004):

Step S1002, a base station sends control signaling to terminal M on a primary carrier frequency of the terminal M through a downlink channel; the control signaling on the primary carrier frequency at least carries the information for indicating the secondary carrier frequency which carries the description information of the part of control signaling, the description information of the part of control signaling of the terminal M on the secondary carrier frequency, and the storage position information on the primary carrier frequency of the changed part of control signaling on the secondary carrier frequency.

Wherein, the control signaling sent on the primary carrier frequency at least comprises the signaling formats as shown in Table 4:

TABLE 4
Control Signaling Format

| Syntax | Notes |
|---|---|
| { | |
| Terminal identifier | The identifier of terminal which can work under multiple carrier |
| | frequencies at the same time |
| Secondary carrier | The bit length equals to the number of the secondary carrier |
| frequency indication | frequency of the terminal, wherein each bit corresponds to one |
| BITMAP | secondary carrier frequency. The number “1” means that the |
| | description information related to the control signaling of the |
| | secondary carrier frequency will be carried subsequently; the number |
| | “0” means that the description information related to the control |
| | signaling of the secondary carrier frequency will not be carried |
| | subsequently. |
| for(i=0;i<sum(BITM | Sum (BITMAP= =1) is the total number of the secondary carrier |
| AP= =1); i++) | frequencies which carries the description information of the part of |
| | control signaling. |
| { | |
| The number of | The number of the control signaling related to the terminal M. |
| counter fields | |
| for(j=0; j<the number | The description information about the variation of different types of |
| of counter fields; j++) | control signaling on the secondary carrier frequency. The terminal |
| { | compares the Counter values of the same type control signaling |
| Counter_j; | between the two moments before and after receiving the signaling. If |
| Address_j; | the two values are same, the corresponding type of control signaling |
| } | does not change and the control signaling does not need to be |
| } | decoded; otherwise, the storage position information Address on the |
| | primary carrier frequency of the changed part of control signaling |
| | needs to be decoded. |
| . . . | |
| } | |

Step S1004, after receiving the control signaling on the primary carrier frequency successfully, the terminal M firstly determines the secondary carrier frequency which carries the description information of the part of control signaling, then determines whether the part of control signaling on the secondary carrier frequency changes according to the description information of the part of control signaling, and finally obtains the storage position information on the primary carrier frequency of the changed part of control signaling.

In the embodiment, through decoding the control signaling on the primary carrier frequency related to the terminal only, compared with the prior art, the present invention overcomes the problem that the power consumption of the terminal increases because the terminal decodes the control signaling on all available carrier frequencies every time, reduces the power consumption of the terminal, prolongs the stand-by time of the terminal, and improves the efficiency of the system.

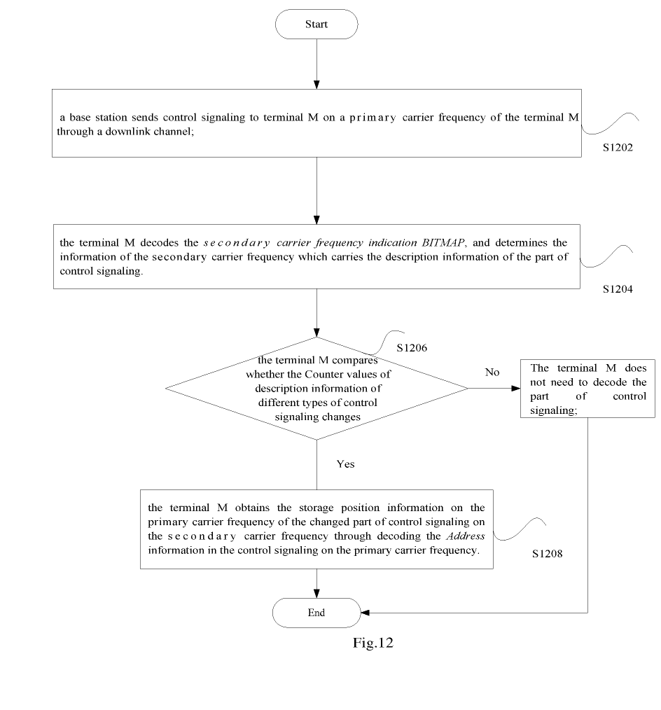

FIG. 11 is a schematic diagram of the system frame structure according to the fourth embodiment of the present invention. FIG. 11 shows another detailed embodiment of the method provided by the present invention in the wireless communication system which uses time division duplexing (TDD) mode. As shown in FIG. 11, three carrier frequencies RF1, RF2 and RF3 are included; the wireless frame is 20ms in length; each frame comprises a preamble, a control channel and etc.; wherein control channels of RF1, RF2 and RF3 are sent in the same time period. Supposing that the carrier frequency RF1 is the primary carrier frequency, and the carrier frequency RF2 and carrier frequency RF3 are the secondary carrier frequencies for the terminal M which can work on the carrier frequency RF1, carrier frequency RF2 and carrier frequency RF3 at the same time, the signaling indication method of the embodiment will be detailed hereafter in conjunction with FIG. 12.

FIG. 12 is a detailed processing flowchart of signaling indication method in a multiple carrier frequency communication system according to the fourth embodiment of the present invention. As shown in FIG. 6, the implementation flow of the detailed embodiment comprises the steps as follows (step S1202-step S1208):

Step S1202, a base station sends control signaling to terminal M on a primary carrier frequency RF1 of the terminal M through a downlink channel;

Step S1204, after receiving the control signaling of the primary carrier frequency successfully, the terminal M determines the secondary carrier frequency which carries the description information of the part of control signaling through decoding the secondary carrier frequency indication BITMAP. In the embodiment, supposing that the RF2 and RF3 both have the part of control signaling related to the terminal M, then the secondary carrier frequency indication BITMAP equals to 11. If only the RF2 has the part of control signaling related to the terminal M, then the secondary carrier frequency indication BITMAP equals to 01. If only the RF3 has the part of control signaling related to the terminal M, then the secondary carrier frequency indication BITMAP equals to 10. If the RF2 and RF3 neither have the part of control signaling related to the terminal M, then the secondary carrier frequency indication BITMAP equals to 00.

Step S1206, after determining the secondary carrier frequency which carries the description information of the part of control signaling, in the control signaling of the primary carrier frequency, the terminal M determines whether the part of control signaling information on the corresponding secondary carrier frequency changes through comparing whether the Counter values of description information of different types of control signaling change. As shown in FIG. 11, in the embodiment, supposing that the part of control signaling of the terminal M on the secondary carrier frequency RF3 does not change (as the dotted rectangle shown in FIG. 11), then the Counter value maintains the original value unchanged, e.g. Counter_{—}1=1 (the original value of Counter_{—}1 is 1); while on the secondary carrier frequency RF2, part of subsequent control signaling changes (as the solid rectangle shown in FIG. 11), then the corresponding Counter value changes, e.g. Counter_{—}1=2 (the original value of Counter_{—}1 is 1). In this case, through comparing the Counter values on a secondary carrier frequency before and after receiving the signaling on the primary carrier frequency, the terminal M knows which type of control signaling changes, instead of decoding the control signaling of all secondary carrier frequencies. Consequently, the power consumption of the terminal is reduced; the stand-by time of the terminal is prolonged; and the efficiency of the system is improved.

Step S1208, after determining the changed part of control signaling, through decoding the Address information in the control signaling on the primary carrier frequency, the terminal M obtains the storage position information on the primary carrier frequency of the changed part of control signaling on the secondary carrier frequency. As shown in FIG. 11, the information of the control signaling (the terminal M) in the RF2 is stored in the control signaling (the terminal M) of the primary carrier frequency RF1; and the Address signaling on the primary carrier frequency RF1 is used to indicate the storage position information on the primary carrier frequency of the changed part of control signaling on the secondary carrier frequency.

According to the above-mentioned embodiments of the present invention, through decoding the control signaling on the primary carrier frequency related to the terminal only, compared with the prior art, the present invention overcomes the problem that the power consumption of the terminal increases because the terminal decodes the control signaling on all available carrier frequencies every time, reduces the power consumption of the terminal, prolongs the stand-by time of the terminal, and improves the efficiency of the system.

Obviously, those skilled in the art shall understand that the above-mentioned modules and steps of the present invention can be realized by using general calculating device, can be integrated in one calculating device or distributed on a network which consists of a plurality of calculating devices. Alternatively, the modules and the steps of the present invention can be realized by using the executable program code of the calculating device. Consequently, the modules and the steps can be stored in the storage device and executed by the calculating device, or the modules and the steps are made into integrated circuit module respectively, or a plurality of modules or steps thereof are made into one integrated circuit module. In this way, the present invention is not restricted to any particular hardware and software combination.

The descriptions above are only preferable embodiments of the present invention, which are not used to restrict the present invention. For those skilled in the art, the present invention may have various changes and variations. Any amendments, equivalent substitutions, improvements etc. within the spirit and principle of the present invention are all concluded in the protection scope of the present invention.

1-22. (canceled)

23. A method for sending signaling in a multiple carrier frequency communication system, comprising: a base station sending control signaling on a primary carrier frequency corresponding to a terminal, and carrying, in the control signaling, indication information for indicating a part of control signaling which needs to be decoded of the secondary carrier frequency.

24. The method for sending signaling in a multiple carrier frequency communication system according to claim 23, wherein
the primary carrier frequency is the carrier frequency resource that the terminal must decode all the control signaling; the secondary carrier frequency is the carrier frequency resource on which the terminal can operate determined by the control signaling on the primary carrier frequency of the terminal, and whether the part of the control signaling on the secondary carrier frequency needs to be decoded is indicated by the control signaling on the primary carrier frequency.

25. The method for sending signaling in a multiple carrier frequency communication system according to claim 23, wherein
the terminal is a terminal which supports simultaneous working under multiple carrier frequencies, or a group of terminal set which supports simultaneous working under multiple carrier frequencies.

26. A method for receiving signaling in a multiple carrier frequency communication system, comprising:
a terminal receiving control signaling sent by a base station on a primary carrier frequency of the terminal, wherein the control signaling carries indication information for indicating a part of control signaling which needs to be decoded of a secondary carrier frequency;
the terminal obtaining the indication information, and determining the secondary carrier frequency on which the part of control signaling needs to be decoded according to the indication information;
the terminal decoding the part of the control signaling on the determined secondary carrier frequency.

27. The method for receiving signaling in a multiple carrier frequency communication system according claim 26, wherein
the primary carrier frequency is the carrier frequency resource that the terminal must decode all the control signaling; the secondary carrier frequency is the carrier frequency resource on which the terminal can operate determined by the control signaling on the primary carrier frequency of the terminal, and whether the part of the control signaling on the secondary carrier frequency needs to be decoded is indicated by the control signaling on the primary carrier frequency.

28. The method for receiving signaling in a multiple carrier frequency communication system according to claim 27, wherein
the indication information comprises a first indication information and a second indication information, wherein the first indication information is used to indicate whether the terminal needs to decode the part of control signaling on the secondary carrier frequency; the second indication information is used to indicate the position on the secondary carrier frequency of the part of control signaling needs to be decoded.

29. The method for receiving signaling in a multiple carrier frequency communication system according to claim 27, wherein
the terminal is a terminal which supports simultaneous working under multiple carrier frequencies, or a group of terminal set which supports simultaneous working under multiple carrier frequencies.

30. A method for receiving signaling in a multiple carrier frequency communication system, comprising:
a terminal receiving control signaling sent by a base station on a primary carrier frequency of the terminal, wherein the control signaling carries indication information for indicating a part of control signaling which needs to be decoded on a secondary carrier frequency;
the terminal obtaining the indication information, and determining the secondary carrier frequency which carries description information of the part of control signaling according to the indication information;
determining whether the part of control signaling on the secondary carrier frequency changes according to the description information of the part of control signaling;
for the secondary carrier frequency that the part of control signaling has changed, the terminal decoding the changed part of control signaling according to the indication information.

31. The method for receiving signaling in a multiple carrier frequency communication system according to claim 30, wherein
the primary carrier frequency is the carrier frequency resource that the terminal must decode all the control signaling; the secondary carrier frequency is the carrier frequency resource on which the terminal can operate determined by the control signaling on the primary carrier frequency of the terminal, and whether the part of the control signaling on the secondary carrier frequency needs to be decoded is indicated by the control signaling on the primary carrier frequency.

32. The method for receiving signaling in a multiple carrier frequency communication system according to claim 31, wherein
the indication information comprises a first indication information and a second indication information, wherein the first indication information is used to indicate the secondary carrier frequency which carries the description information of the part of control signaling; the second indication information is used to indicate the position on the secondary carrier frequency of the part of control signaling needs to be decoded.

33. The method for receiving signaling in a multiple carrier frequency communication system according to claim 31, wherein
the terminal is a terminal which supports simultaneous working under multiple carrier frequencies, or a group of terminal set which supports simultaneous working under multiple carrier frequencies.

34. A method for sending signaling in a multiple carrier frequency communication system, comprising, a base station sending control signaling on a primary carrier frequency corresponding to a terminal, wherein the control signaling carries indication information for indicating the position on the primary carrier frequency of the control signaling which needs to be decoded of a secondary carrier frequency.

35. The method for sending signaling in a multiple carrier frequency communication system according to claim 34, wherein
the primary carrier frequency is the carrier frequency resource that the terminal must decode all the control signaling; the secondary carrier frequency is the carrier frequency resource on which the terminal can operate determined by the control signaling on the primary carrier frequency of the terminal, and whether the part of the control signaling on the secondary carrier frequency needs to be decoded is indicated by the control signaling on the primary carrier frequency.

36. A method for receiving signaling in a multiple carrier frequency communication system, comprising:
a terminal receiving control signaling sent by a base station on a primary carrier frequency of the terminal, wherein the control signaling carries indication information for indicating the position on the primary carrier frequency of a part of control signaling which needs to be decoded of a secondary carrier frequency;
the terminal obtaining the indication information, and determining the position on the primary carrier frequency of the part of control signaling related to the terminal on the secondary carrier frequency.

37. The method for receiving signaling in a multiple carrier frequency communication system according to claim 36, wherein
the primary carrier frequency is the carrier frequency resource that the terminal must decode all the control signaling; the secondary carrier frequency is the carrier frequency resource on which the terminal can operate determined by the control signaling on the primary carrier frequency of the terminal, and whether the part of the control signaling on the secondary carrier frequency needs to be decoded is indicated by the control signaling on the primary carrier frequency.

38. The method for receiving signaling in a multiple carrier frequency communication system according to claim 37, wherein
the terminal is a terminal which supports simultaneous working under multiple carrier frequencies, or a group of terminal set which supports simultaneous working under multiple carrier frequencies.

39. A method for receiving signaling in a multiple carrier frequency communication system, comprising:
a terminal receiving control signaling sent by a base station on a primary carrier frequency of the terminal, wherein the control signaling carries indication information for indicating a part of control signaling which needs to be decoded of a secondary carrier frequency;
the terminal obtaining the indication information, and determining the secondary carrier frequency which carries description information of the part of control signaling according to the indication information;
determining whether the part of control signaling on the secondary carrier frequency changes according to the description information of the part of control signaling;
for the secondary carrier frequency that the part of control signaling has changed, the terminal determining the position on the primary carrier frequency of the changed part of control signaling according to the indication information.

40. The method for receiving signaling in a multiple carrier frequency communication system according to 39, wherein
the primary carrier frequency is the carrier frequency resource that the terminal must decode all the control signaling; the secondary carrier frequency is the carrier frequency resource on which the terminal can operate determined by the control signaling on the primary carrier frequency of the terminal, and whether the part of the control signaling on the secondary carrier frequency needs to be decoded is indicated by the control signaling on the primary carrier frequency.

41. The method for receiving signaling in a multiple carrier frequency communication system according to claim 40, wherein
the indication information comprises a first indication information and a second indication information, wherein the first indication information is used to indicate the secondary carrier frequency which carries the description information of the part of control signaling; the second indication information is used to indicate the position on the primary carrier frequency of the changed part of the control signaling on the secondary carrier frequency.

42. The method for receiving signaling in a multiple carrier frequency communication system according to claim 40, wherein
the terminal is a terminal which supports simultaneous working under multiple carrier frequencies, or a group of terminal set which supports simultaneous working under multiple carrier frequencies.
